(19) United States
(12) Patent Application Publication
(10) Pub. No.: US 2021/0154858 A1
(43) Pub. Date: May 27, 2021

(54) THREE DIMENSIONAL STRUCTURE WITH SENSOR CAPABILITY

(71) Applicant: THE UNIVERSITY COURT OF THE UNIVERSITY OF GLASGOW, Glasgow, Strathclyde (GB)

(72) Inventors: Ravinder DAHIYA, Glasgow, Strathclyde (GB); Dhayalan SAKTHIVEL, Glasgow, Strathclyde (GB); William Navaraj TAUBE, Glasgow, Strathclyde (GB)

(73) Assignee: THE UNIVERSITY COURT OF THE UNIVERSITY OF GLASGOW, Glasgow, Strathclyde (GB)

(21) Appl. No.: 16/614,099

(22) PCT Filed: May 14, 2018
(86) PCT No.: PCT/EP2018/062346

§ 371 Date: Nov. 15, 2019

(30) Foreign Application Priority Data
May 15, 2017 (GB) 1707743.9

(51) Int. Cl. B25J 13/08; G01L 1/24; G01L 5/22

(52) U.S. Cl. CPC B25J 13/084; G01L 5/228; G01L 1/247

(57) ABSTRACT

This invention relates to a device for sensing interaction with its surrounding environment, the device including: a plurality of sensing points (11); a plurality of detectors (12), each associated with one of said sensing points (11) and located remotely therefrom; a plurality of channels (14) which connect said sensing points (11) to said detectors (12) and provide a communication pathway therebetween; and communication media filling the channels, wherein each detector (12) is in communication with the associated sensing point or points (11) through one of said channels (14) and the medium in said channel (14) is arranged to transmit, transfer or transduce an interaction of the sensing point (11) with its surrounding environment to the detector (12) through the channel (14). The invention also relates to prosthetics which incorporate such devices. The devices according to the present aspect integrate sensing points and sensors within the structure of the device rather than adding an extra sensing layer to the structure and can overcome the traditional problems associated with the wiring when providing sensors on a robot arm or prosthetic.

### FIELD OF THE INVENTION

The present invention relates to a three dimensional structure with sensor capability and devices incorporating such structure. It is particularly, but not exclusively, concerned with structures for artificial limbs which provide for sensor capability on those limbs.

### BACKGROUND OF THE INVENTION

Conventionally, to provide a structure such as a robotic hand with sensor capability so as to allow it to obtain information about the environment or object that it comes into contact with, discrete sensors and/or sensor electronics on rigid or flexible substrates are placed on the exterior of the structure.

An existing technology that takes a different approach to sensors on robotic hands is the BioTac®, produced by SynTouch LLC of Los Angeles, Calif. and described in, for example, U.S. Pat. Nos. 7,658,119B and 7,878,075B. FIG. 1 shows a cross-sectional view though the BioTac® sensor.

As shown in FIG. 1, the sensor has an incompressible conductive fluid contained within an elastomeric cover at the tip of the “finger”. Distributed impedance sensors are used to calculate the point of tactile input on the cover. This requires complex electronics and/or processing capability. In the commercialised version of Bio-Tac, one more pressure sensor is used and the signal is interpreted in frequency domain. However, due to the sensor having a single reservoir of fluid, the device can suffer from cross talk or interference between the sensors, which can make it difficult to determine the exact point of touch.

An object of the present invention is to provide structures having sensor capability which allow sensing of the environment around the structure by detectors which are remote from the location being sensed.

A further object of the present invention is to provide structures with sensor capability which have reduced requirements for wiring and electrical connections on or within the structure.

A further object of the present invention is to provide methods of manufacturing three dimensional devices having sensor capability.

### SUMMARY OF THE INVENTION

At its broadest, aspects of the present invention provide a sensor having a plurality of channels which provide communication pathways between the point of interaction of the sensor and the detectors and robot arms and prosthetics incorporating such devices.

A first aspect of the present invention provides a device for sensing interaction with its surrounding environment, the device including: a plurality of sensing points; a plurality of detectors, each associated with one of said sensing points and located remotely therefrom; a plurality of channels which connect said sensing points to said detectors and provide a communication pathway there-between; and communication media filling the channels, wherein each detector is in communication with the associated sensing point or points through one of said channels and the medium in said channel is arranged to transmit, transfer or transduce an interaction of the sensing point with its surrounding environment to the detector through the channel.

Devices according to the present aspect integrate sensing points and sensors within the structure of the device (rather than adding an extra sensing layer to the structure).

In embodiments of the first aspect, the plurality of channels can be realized within 3D printed structures, and the channels can be filled with communication media which transduce the information from a sensing point to the point/region where the detector and/or embedded electronics are located.

The arrangement of the device of the present aspect can also help overcome the traditional problems associated with the wiring when providing sensors on a robot arm or prosthetic which is the number of wires required to convey information from a plurality of sensors and the need to accommodate those wires within a “skin” that conforms to the surface.

By providing the actual detectors remotely from the sensing point, the size of the detectors is less important (for example because it does not interfere with or affect the sensing functions), which means that cheaper and/or more sensitive detectors can be used.

Therefore, when enabling the device of the present aspect, the complexity of the wiring and the electronics can be reduced compared to existing arrangements.

In preferred embodiments of the present aspect, the communication media in at least one of the channels, and optionally more, including all the channels, are fluids (preferably liquids, but they may also be gases such as air). However, the media may also be solids, including gels, elastomers and other polymer materials such as Polydimethylsiloxane (PDMS) or composites or silica based waveguides or fibre optics, which can transduce through light.

The device may also have reservoirs associated with one or more (preferably each) of the sensing points to provide a store of the communication medium. The channels may then link the reservoirs to the detectors. In certain embodiments the reservoir may simply be a region at the end of the channel closest to the sensing point.

By using distributed interfaces, devices according to the present aspect may be able to obtain a precise localised point of tactile input (or other sensed interaction). It may also be possible to carry out frequency domain analysis to determine, for example, the texture of a surface which is contacted by the device

Preferably the interaction of the sensing point with its surrounding environment causes a change in a property of the communication medium in said reservoir and/or channel, and the detectors are arranged to detect changes in said property of the medium.

In certain embodiments there are at least two types of said detectors, each type of detector being arranged to detect a different change in a property of the medium. Thus the device can detect different interactions with the environment at different ones of the sensing points, providing a range of different information.

In a particularly preferred selection of embodiments, the interaction for at least one of said sensing points is touch, and the detector associated with said at least one sensing point is a pressure sensor arranged to detect a change in pressure of the communication medium. Touch sensitivity is particularly important for robot arms and prosthetics.

In certain embodiments of the device, the channels have a larger cross section where they connect to the sensing point than they do where they connect to the detectors. This arrangement is particularly relevant to touch sensing as it allows the interaction of the sensing point to be magnified at the detector due to the narrowing of the channel between the sensing point and the detector.

Preferably the communication medium in the channels is substantially incompressible. This allows the fluid to accurately transduce the interaction at a sensing point to a detector.

In certain embodiments at least one of the detectors is arranged to detect at least one of the following in or passing through the communication medium: electromagnetic radiation, including infra-red, visible and ultra-violet radiation; electrical properties, including changes in electrical potential and conductivity; magnetic properties; radioactivity and changes resulting from radioactive interactions. Such detectors allow a wide range of interactions with the environment surrounding the sensing points to be detected or monitored.

In certain embodiments the device includes a transmitter which is arranged to transmit radiation to the surrounding environment of the device, wherein at least one of the detectors is arranged to detect the interaction of said transmitted radiation with the surrounding environment in the vicinity of an associated sensing point.

In particular, the transmitter may be arranged to transmit said radiation through the communication medium in one of said channels.

Preferably the sensing points are arranged in a regular pattern on one surface of the device.

In certain embodiments the sensing points may be arranged on a first surface of the device and the detectors may be arranged on a surface substantially opposite said first surface. For example the sensing points may be on the “front” of the “hand” of a prosthetic and the detectors arranged on the “back”.

The device may further include a processor, wherein the processor is arranged to process signals from said detectors. The processor is preferably arranged to process the signals from at least two of said detectors and use said processed signals in combination in order to determine information about the surrounding environment. The processor may be adapted to use hardware or software neural networks for pattern recognition or neuronal sensing, or to interact with such networks.

The device of the present aspect may include any combination of some, all or none of the above described preferred and optional features.

Further aspects of the present invention provide a robotic arm having a device according to the above first aspect, including some, any or all of the optional or preferred features of that aspect and a prosthetic having a device according to the above first aspect, including some, any or all of the optional or preferred features of that aspect.

The use of bio-inspired devices such as those in the first aspect above may give an effective tactile feedback for robotic manipulators and prosthetics.

A further aspect of the present invention provides a method of manufacturing a structure for a sensing device, the method including the steps of: forming, by an additive manufacturing process, a device having: a body; a plurality of reservoirs within said body designed to accommodate a communication medium and having at least one side located on the exterior of the finished device, said at least one side being formed from a different material to the body; and a plurality of channels connected to said reservoirs and passing at least partly through the body, and filling said reservoirs and said channels with a communication medium.

The structure for the sensing device may be a device according to the above described first aspect, including some, any or all of the optional or preferred features of that aspect.

The device of the first aspect is particularly suitable for manufacturing by an additive manufacturing process as this allows the channels to be formed in the device when it is constructed as well as allowing the different materials of the body and the at least one side to be co-formed.

The reservoirs may provide a store of the communication medium. In certain embodiments the reservoir may simply be a region at the end of the channel closest to the sensing point.

Preferably the at least one side is a flexible material once formed and the body is a rigid material once formed. The flexible material may then form the sensing point for, for example, a touch sensor.

In preferred embodiments of the present aspect, the communication medium is a fluid (preferably a liquid, but may also be a gas such as air). However, the medium may also be a solid, including a gel, elastomer and other polymer material.

The method of the present aspect may include any combination of some, all or none of the above described preferred and optional features.

A further aspect of the present invention provides an apparatus for manufacturing a structure for a sensing device, the apparatus having: an additive manufacturing unit which has: a supply of raw material; a moveable forming head for depositing raw material in a shape to be formed; a conduit for passing raw material from the supply to the forming head; and a curing device for curing the raw material into a final form, and a media-filling unit which has: a supply of a communication medium; a moveable filler head; and a conduit for passing the medium from the supply to the filler head, and a processor arranged to control the movement of said forming head and said filler head and to control the supply of raw material and communication medium.

The apparatus may be operated in accordance with a method according to the above described aspect, including some, any or all of the optional or preferred features of that aspect.

In certain embodiments, the apparatus has two supplies of raw material and/or two supplies of communication media and the processor is arranged to control which of said raw materials and/or said communication media is supplied. Thus different materials in the structure can be co-formed as part of the same additive manufacturing process, and parts of the sensing device which are going to form sensors can be filled with different fluids depending on the type of sensor desired.

In preferred embodiments of the present aspect, the communication medium or media are fluids (preferably liquids, but they may also be gases such as air). However, the media may also be solids, including gels, elastomers and other polymer materials.

The apparatus of the present aspect may include any combination of some, all or none of the above described preferred and optional features.

### BRIEF DESCRIPTION OF THE DRAWINGS

Embodiments of the invention will now be described by way of example with reference to the accompanying drawings in which:

FIG. 1 shows, schematically, a cross-section through the prior art BioTac® sensor and has already been described;

FIG. 2 shows, schematically, a cross-section through a device according to an embodiment of the present invention;

FIG. 3 shows a prosthetic/robot hand according to an embodiment of the present invention;

FIG. 4 shows the distributed fluidic interfaces of sensor structures according to embodiments of the present invention;

FIG. 5 shows, schematically, a further embodiment of the present invention which uses an alternative sensor arrangement; and

FIG. 6 shows an apparatus according to a further embodiment of the invention for manufacturing sensor devices.

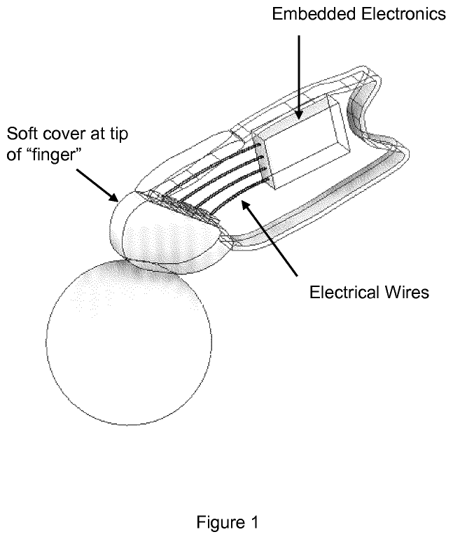

### DETAILED DESCRIPTION

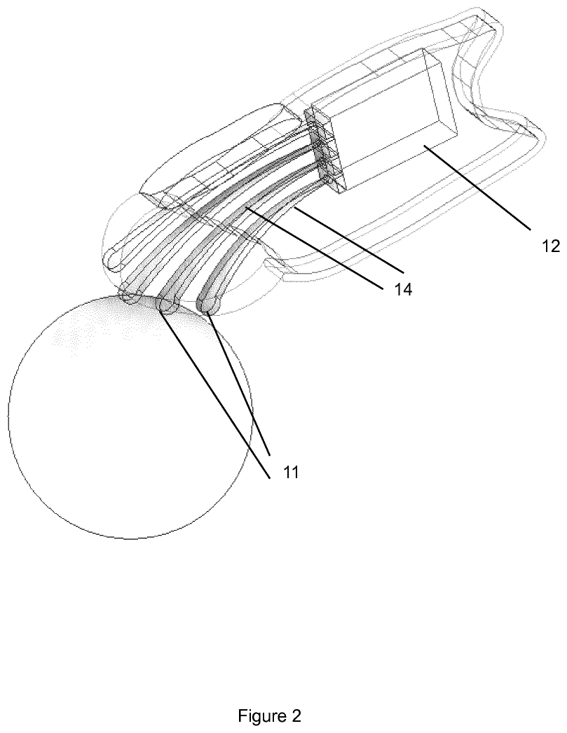

FIG. 2 shows, schematically, a cross-section through a device according to an embodiment of the present invention in order to illustrate the principles of the embodiment. The device has a plurality of distributed fluidic interface channels 14 which connect sensing points 11 to the embedded sensors and sensor electronics 12. The fluid in the channels 14 transmits, transfers or transduces the interaction from the sensing point 11 to a remotely-located sensor. In the case illustrated in FIG. 2, the interaction is touch which is transferred by pressure in the fluid in channel 14.

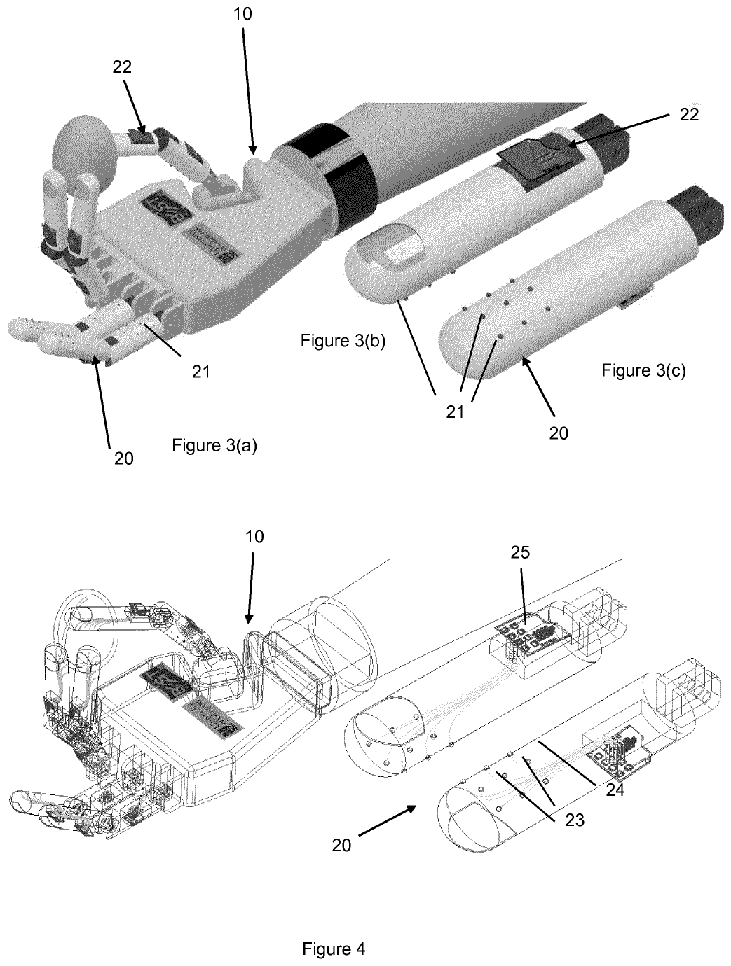

FIG. 3 shows a prosthetic/robotic hand 10 according to an embodiment of the present invention, and in which each “finger” 20 constitutes a device according further embodiments of the present invention, holding an egg. FIG. 3(a) shows the entire hand 10, whilst FIGS. 3(b) and 3(c) show the back and front of a single finger 20 from the hand. In the embodiment of FIG. 3, all of the fingers 20 on the hand 10 are identical, but they need not be, both in terms of physical configuration (e.g. number and arrangement of sensory protrusions) or purpose (e.g. what is sensed by the sensors on the finger).

Each finger 20 has a plurality of sensory protrusions 21 at the edge of the finger, each formed of an elastomeric material and enclosing a fluid reservoir (not visible in FIG. 3). A plurality of channels (not visible in FIG. 2) lead from the protrusions 21 to the sensor components and electronics housing 22. Although the fingers 20 shown in FIG. 3 have 9 sensory protrusions arranged in a 3×3 square grid, this is purely for illustrative purposes and any number of protrusions could be provided in any configuration, fundamentally limited only by the space on the “finger” 20.

The images in FIG. 4 directly correspond to the respective images shown in FIG. 3, but instead show the internal fluid and electronic connections within the interior of the prosthetic/robotic hand 10. As shown in FIG. 4, each of the sensory protrusions 21 covers a small fluid reservoir 23 within the structure of the finger. A channel 24 provides fluid communication between the reservoir and the sensor circuit 25 which is located on the rear of each finger 20. The sensors of the embodiment shown in FIGS. 2 and 3 are touch sensors. However, as described below, the sensors may detect many different aspects of the environment surrounding the sensory protrusions either individually or in combination. The exact format and arrangement of the sensor will depend on its intended purposes.

The distributed embedded fluidic channels 24 inside the structure act as a medium to carry or transfer the physical parameters of interest such as pressure, temperature, ambient light etc. from the sensory protrusions 21 to the sensing region(s) 25 which is at a different location within the structure of the device.

In the embodiment shown in FIG. 4, the channels 24 are identical. However, as discussed above in relation to the “fingers”, they need not be and may have different dimensions (which may be determined by or occasioned by the purpose of the sensing regions). Alternatively or additionally, the channels may be configured such that a single physical channel through the structure of the hand 10 is sub-divided into sub-channels each of which is designed to convey a different parameter from the sensory protrusions 21 to the sensing regions 25.

Although an obvious use for the devices of the above embodiments is to sense touch through transmission of pressure through fluid in the channels, many other arrangements are possible both to detect other interactions of the device, and also to measure or monitor touch.

For example, in addition to using electronic sensing of pressure, visual imaging techniques could be used to determine or measure the amount of contact force and/or the area of contact with the sensory protrusion. This can be done by having a resilient membrane at the sensor end of the channel (remote from the sensing point) and video recording the change in the size of the liquid “bubble” at that position.

In this (and other embodiments), the optical sensing/probing electronics at the detector side could be a single photodetector, or 1D/2D array of optical sensors acting as a camera and/or with digital micromirror devices (DMD) and/or with other photonic devices.

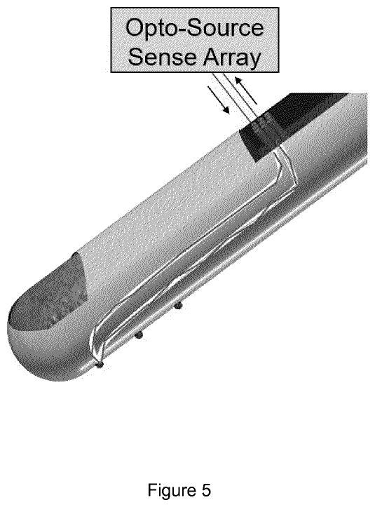

FIG. 5 illustrates a device according to a further embodiment in which one of the channels is used to transmit light (or other radiation) from the detector end to the sensory protrusion so that the interaction of that light/radiation with the environment surrounding the sensory protrusion can be detected, for example from the reflection/scattering of the radiation which can be picked up by one or more of the sensory protrusions (including the one responsible for transmission of the radiation) and transmitted back to the sensor circuits associated with those channels.

Further embodiments of the invention use material in the channels which has an inherent sensing property such as change in its optical, electrical or any other physical parameters.

In particular, different channels within the same device may be used to measure different contact parameters. This can make the device effectively start to mimic human skin, which is able to measure multiple parameters.

However, in the embodiments of the present invention, it is possible to go beyond the abilities of human skin as some of the channels could be used to measure parameters that are not possible with human skin and this may result in much wider scope of sensing devices according to embodiments of the present invention. For example, liquid sensitive to radiation or light could be used to measure additional parameters.

Further, the channel structure itself can be designed depending on the interaction that is being sensed and the fluid(s) and sensor(s) used.

For example, as shown in the embodiment illustrated in FIG. 2, the channels 14 may have varying diameters along the channel length. The use of 3D printing is beneficial as it makes it easier to implement such innovative structures. The pneumatic/fluidic channel structure with varying diameter can act like mechanical amplifier for the contact parameter. For example, because of fixed channel volume, a small displacement of liquid at the contact point end (where channel diameter is larger), will appear as a larger liquid displacement at electronics end (where channel diameter is smaller).

One advantage of this approach is that it can relax constraints on the sensors and associated electronics in terms of amplification, which may further simplify the electronics and/or make the sensors or electronics cheaper.

Table 1 below sets out a wide range of materials which can be used in the channels of devices according to embodiments of the invention, depending on the target application. For some sensing mechanisms it may be desirable to have heterogeneous integration of two or more materials of different types.

An example of such a configuration is where a 3D printed fluidic/flexible interface such as optic material within the finger can be used as a pathway for laser or LED light guided through the channel containing that material via total internal reflection or scattering/reflection. The light may then hit the object being touched (or in near proximity) and then collected, either through the same pathway or using a different channel.

This configuration can result in infrared sensing or composition detection sensors positioned at the tip of the robotic hand's “finger”. This configuration can also be used to detect the type of material contacted by artificial finger as frequency shifts (which vary with contact materials) may be used as a “signature” of the material in contact with the finger and by comparison with a reference database, then the type of material determined.

TABLE 1

| Sensing property | Suitable materials for the protrusion and/or channel |
|---|---|
| Optical | Non-absorbing optical materials of various refractive indices |
| | (e.g. Hydrosiloquinone (HSQ) which, on annealing will |
| | become Silica, DI Water, Mineral Oil etc.) |
| Electrical | Conductive Gels, Ion-gel, nanocomposites etc. |
| Thermal | Graphene, Carbon Nano Tubes(CNTs), Copper |
| Mechano-electrical | Piezopolymers such as PVDF-TrFE |
| Magnetic Materials | Ferrofluid (Magnetite, Ferrite, Iron, Cobalt) |
| Electrochemical | Metal Oxide/Polymer Mixtures, CNT or graphene (for |
| (Gas, solution/ | example the sensory protrusion the finger may be made of |
| Humidity or pH) | or coated with a gas sensing or humidity sensitive material |
| Sensitive | (for example a functionalized CNT). The channel will act a |
| Material | medium to pass a probing electromagnetic beam (e.g. infr- |
| | red radiation) whose interaction with the sensitive material |
| | can then be received at the other end of the channel.) |
| | Through this also spatial mapping may also be possible. |
| | Another example is to use a colour-changing material at tip |
| | where the material changes colour depending on the |
| | environment surrounding the sensory protrusion (as pH |
| | indicators do). This colour may be transmitted through the |
| | channel to the sensing device. |
| | In another example, a ferrofluid may be used on the sensory |
| | protrusion, such that its orientation can be detected by a |
| | probing beam. |

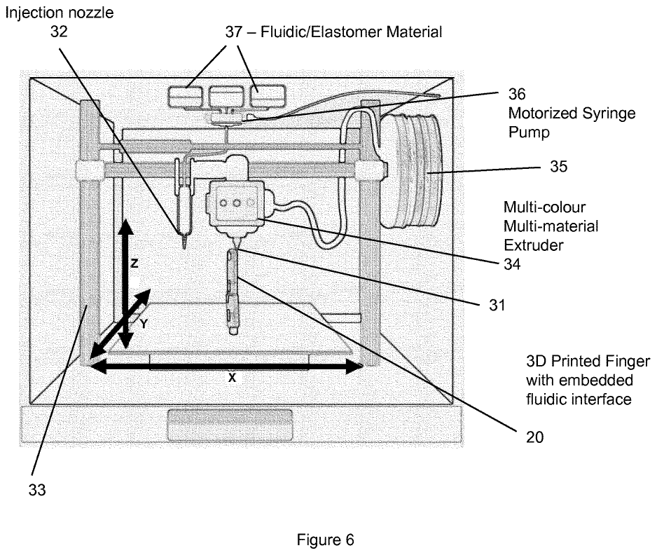

Further embodiments of the present invention relate to methods of manufacturing a sensing device and apparatuses for manufacturing sensing devices. Examples of these embodiments will now be described with reference to FIG. 6. Whilst the embodiment below focuses on 3D printing of a plastic structure, it will be readily appreciated that other additive manufacturing techniques could be used, for example fused deposition modelling (FDM), stereolithography (SLA) or selective laser melting/printing (SLM/SLP), for both plastic and metal structures.

Using an additive manufacturing process such as 3D printing the body of the device and the embedded fluidic interfaces can be co-printed/co-fabricated using a flexible/fluidic material while printing the rigid body. Alternatively, the device could be fabricated in a two-step process by first making the rigid body then filling it with the fluidic/flexible material.

The structural materials for the device may be, for example, metals and metal alloys (e.g. Titanium, Stainless Steel etc.) or plastics (e.g. ABS, PLA etc.). All of these can be fabricated using a 3D printing process. However, they may also be thermoformed or made through other conventional fabrication methods.

FIG. 6 shows an apparatus for manufacturing a sensing device 20 according to an embodiment of the present invention. The apparatus is an adaption of existing 3D printing devices which combines a 3D printing head 31 with a motorized injection syringe 32.

The printing head 31 and syringe 32 are movable and controlled in multi-dimension space by a controller (not shown) driving precision motors on a support frame 33 to position them correctly at all times during the manufacturing process.

The printing head 31 is connected via a multi-material extruder (which is also controlled by the controller) 34 to a plurality of material sources 35. The materials contained in the material sources 35 may have different colours, but may also have different properties when extruded or laid. For example, at least one of the materials may be elastomeric when printed and thus can be used to form the surface of a sensory protrusion on a device, whilst another of the materials may form a strong rigid structure and be used for the framework of the device.

The syringe 32 is connected to a plurality of fluid reservoirs 37 through a motorized syringe pump 36 (also controlled by the controller). The fluid reservoirs contain fluids which are to be filled into the channels in the device and may have different sensory properties, for example as described in Table 1 above.

The apparatus may also have a laser head (not shown) for localized annealing wherever necessary.

When manufacturing a device according to an embodiment of the present invention, the controller positions the printing head 31 in three-dimensional space according to a pre-programmed design for the device and extrudes material from the material sources 35. The printing head 31 moves to form the body of the device (including the channels within that structure). Complex 3D structures (e.g. channels of varying cross-section) can be readily achieved using 3D printing (or other additive manufacturing techniques).

The printing head may also form the sensory protrusions (or other configurations of the sensing points) from a different material to that of the body of the device, for example from an elastomeric material or from a material that is transparent to certain radiation. Thus the sensing points can be co-formed with the body of the device and the possibility of fluid leakage from the channels substantially reduced or eliminated.

Once channels within the body of the device have been formed by the printing head 31, the syringe 32 is moved into a position where it can fill the channels. This may be by leaving a small hole in the end of the channel through which the fluid is injected, or by allowing gravity fill of the channel by the orientation in which the device is manufactured. The controller controls the position of the syringe and the selection of fluid such that each channel can be filled with a selected fluid from the fluid reservoirs 37 according to the intended sensing function of the channel. The channel may then be sealed (at least temporarily) by further deposition from the printing head 31.

Whilst the above embodiments have been described in relation to a prosthetic hand 10, and prosthetics are important embodiments of the present invention, it will be appreciated that the sensing device need not have an anthropomorphic shape and configuration and embodiments of the invention include robots and sensing devices on robots, which could be formed on any part of the robot and in any shape or configuration. Devices of this nature can be used in a wide range of applications including aerospace, marine/wind turbines, nuclear energy, environment monitoring etc.

In the case of prostheses, the parameters of interest related to tactile sensing are pressure, temperature and humidity etc. However, for robotic applications, this may go beyond the requirement of prosthetics where the robotic limbs will be useful for applications such as fruit sorting, or material/structural defect identification in an industrial environment etc. Various conventional fabrication materials as well as smart materials could be useful for such applications.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

Techniques such as injection moulding or metal casting could be used as an alternative manufacturing technique to produce a sensing structure made up of flexible and rigid polymers. These methods may be suitable for manufacturing the sensing device (e.g. as described in the above embodiments) in view of their higher volume (mass production) compared to 3D printing techniques. A metallic mould (cavity) is prepared as per the required design specification which is used for the production process. This mould is filled with the required plastic or metal material depending on the type of fabrication. The same mould could be used to produce thousands of pieces of the sensing structure. The channels and reservoirs can then be filled with the sensory materials in the second step.

### REFERENCES

U.S. Pat. No. 7,658,119;
U.S. Pat. No. 7,878,075.
Truby, Ryan L., and Jennifer A. Lewis. “Printing soft matter in three dimensions.” Nature 540.7633 (2016): 371-378.
US Patent application 2014/0257518 A1
U.S. Pat. No. 9,440,397
US Patent application 2013/0079693 A1

All references referred to above are hereby incorporated by reference.

1. A device for sensing interaction with its surrounding environment, the device including:
a plurality of sensing points;
a plurality of detectors, each associated with one of said sensing points and located remotely therefrom;
a plurality of channels which connect said sensing points to said detectors and provide a communication pathway there-between; and
communication media filling the channels,
wherein each detector is in communication with the associated sensing point or points through one of said channels and the medium in said channel is arranged to transmit, transfer or transduce an interaction of the sensing point with its surrounding environment to the detector through the channel.

2. The device according to claim 1 wherein interaction of the sensing point with its surrounding environment causes a change in a property of the communication medium in said channel, and the detectors are arranged to detect changes in said property of the medium.

3. The device according to claim 1 or claim 2 wherein there are at least two types of said detectors, each type of detector being arranged to detect a different change in a property of the communication media.

4. The device according to claim 1 any one of the preceding claims wherein the interaction for at least one of said sensing points is touch, and the detector associated with said at least one sensing point is a pressure sensor arranged to detect a change in pressure of the communication medium.

5. The device according to claim 4 further wherein the channels have a larger cross section where they connect to the sensing point than they do where they connect to the detectors.

6. The device according to claim 4 or claim 5 wherein the communication medium is substantially incompressible.

7. The device according to claim 1 any one of the preceding claims wherein at least one of the detectors is arranged to detect at least one of the following in or passing through the communication media: electromagnetic radiation, including infra-red, visible and ultra-violet radiation; electrical properties, including changes in electrical potential and conductivity; magnetic properties; radioactivity and changes resulting from radioactive interactions.

8. The device according to claim 1 wherein the device includes a transmitter which is arranged to transmit radiation to the surrounding environment of the device, wherein at least one of the detectors is arranged to detect the interaction of said transmitted radiation with the surrounding environment in the vicinity of an associated sensing point.

9. The device according to claim 8 wherein the transmitter is arranged to transmit said radiation through the communication medium in one of said channels.

10. The device according to claim 1 wherein the sensing points are arranged in a regular pattern on one surface of the device.

11. The device according to claim 1 wherein the sensing points are arranged on a first surface of the device and the detectors are arranged on a surface substantially opposite said first surface.

12. The device according to claim 1, further including a processor, wherein the processor is arranged to process signals from said detectors.

13. The device according to claim 12 wherein the processor is arranged to process the signals from at least two of said detectors and use said processed signals in combination in order to determine information about the surrounding environment.

14. The device according to claim 1 wherein at least one of the communication media is a fluid.

15. A device according to claim 1 incorporated in one of a robotic arm and a prosthetic.

16. (canceled)

17. A method of manufacturing a structure for a sensing device, the method including the steps of:
forming, by an additive manufacturing process, a device having:
a body;
a plurality of reservoirs within said body designed to accommodate a communication medium and having at least one side located on the exterior of the finished device, said at least one side being formed from a different material to the body; and
a plurality of channels connected to said reservoirs and passing at least partly through the body, and
filling said reservoirs and said channels with a communication medium.

18. The method according to claim 17 wherein the at least one side is a flexible material once formed and the body is a rigid material once formed.

19. The method according to claim 17 or claim 18 wherein the communication medium is a fluid.

20. An apparatus for manufacturing a structure for a sensing device, the apparatus having:
an additive manufacturing unit which has:
a supply of raw material;
a moveable forming head for depositing raw material in a shape to be formed;
a conduit for passing raw material from the supply to the forming head; and
a curing device for curing the raw material into a final form, and
a media-filling unit which has:
a supply of a communication medium;
a moveable filler head; and
a conduit for passing the medium from the supply to the filler head, and
a processor arranged to control the movement of said forming head and said filler head and to control the supply of raw material and communication medium.

21. The apparatus according to claim 20 wherein the apparatus has two supplies of raw material and/or two supplies of communication media and the processor is arranged to control which of said raw materials and/or said communication media is supplied.

22. The apparatus according to claim 20 or claim 21 wherein the communication medium or media are fluids.
